(19) United States
(12) Patent Application Publication
(10) Pub. No.: US 2021/0317991 A1
(43) Pub. Date: Oct. 14, 2021

(54) TEMPERATURE MODULATION IN A COOKING APPARATUS

(71) Applicant: PIONEERING TECHNOLOGY CORP., Mississauga (CA)

(72) Inventors: Kevin CALLAHAN, Toronto (CA); Dan MACDONALD, Aurora (CA); Timothy Soe Moe THU, Mississauga (CA); Wayne ZU, Oakville (CA)

(21) Appl. No.: 16/950,192

(22) PCT Filed: May 17, 2019
(86) PCT No.: PCT/CA2019/050681

§ 371 Date: Nov. 17, 2020

Related U.S. Application Data
(60) Provisional application No. 62/673,423, filed on May 18, 2018.

(51) Int. Cl. F24C 7/08; H05B 1/02

(52) U.S. Cl. CPC F24C 7/083; H05B 2213/07; H05B 1/0266; F24C 7/087

(57) ABSTRACT

A heat modulating system includes a heat source, a temperature sensor proximate the heat source, and a controller in connection with the temperature sensor and the heat source. The controller modulates a rate of temperature increase of the heat source based on temperature detected by the temperature sensor, and at a temperature set point detected by the temperature sensor the controller modulates power to the heat source to help to prevent unintended autoignition of cooking oil.

### CROSS-REFERENCE TO RELATED APPLICATIONS

This application claims priority from U.S. Provisional Patent Application No. 62/673,423 filed on May 18, 2018, the contents of which are hereby incorporated by reference.

### FIELD

This relates to a temperature modulation of a heating or cooking element for an electrically powered cooking appliance, particularly where the temperature is limited or controlled as a fire prevention measure to be below an autoignition temperature of commonly used cooking oils, grease and common household materials.

### BACKGROUND

Cooking is a leading cause of residential fires. Fires and smoke caused by cooking contribute to a significant number of preventable deaths, personal injuries, and property damage. Thus, the prevention of kitchen fires may be important to a wide array of stakeholders, including individuals, building management companies, insurance companies and fire departments.

Homes, student residences, retirement residences, hotel suites with kitchens, and the like where individuals prepare food alone or in an unsupervised non-professional environment may be the scene of kitchen fires due to lack of proper attention, oil spills, grease build-up, carelessness, forgetfulness, and lack of awareness of safe cooking procedures.

Stoves and heating elements cause kitchen fires because the temperature of hot surfaces can exceed the autoignition temperature of many cooking oils, foods, paper, cloth and building materials that may come into contact with the hot surface. The autoignition temperature of a substance is the lowest temperature at which the substance spontaneously ignites without an external source of ignition (such as flame or spark).

This problem has been recognized by Underwriters Laboratories in the UL Standard for Safety for Household Electric Ranges (UL 858). For example, UL 858 60A provides an Abnormal Operation & Coil Surface Unit Cooking Oil Ignition Test. In this test, an electric coil stovetop, at its maximum setting, must not cause cooking oil within a cast iron pan to ignite within 30 minutes.

U.S. Pat. No. 6,246,033 to Shah provides a temperature controlled electric heating element. However, due to the complexity of the internal stove circuit modifications required, installation must be carried out by a trained appliance service person.

Although electric stoves with individual elements are still popular due to lower cost, electric stoves with a single glass cook top having multiple burners in a single unit are becoming increasingly popular due to aesthetics and the ease of maintenance.

To clean an electric coil stovetop, a person may need to clean the coil itself, drip pans, and the housing itself. In contrast, since the heating element is underneath a glass surface, there is only one surface to clean for a glass top stove. Further, since the surface is smooth, there are no crevices where oils and grease can accumulate, reducing potential sites where unintended fires can start.

Cooking by way of stoves and heating elements provides heat transfer to cook a food by way of conduction—heat is transferred between objects through direct contact, for example, from a heating element, to a cooking vessel or cookware, to the contents of the cookware.

Different cooking techniques depend upon different heat transfer conditions, which may impact the cooking effectiveness. For example, it may be desirable to cook certain foods hot and fast, while others low and slow. The heat transfer conditions may be impacted by the ability of a heating element to reach a desired temperature, and how quickly the heating element can reach such temperature.

Accordingly it is desirable to provide a temperature controlled or limiting electric heating element that reduces fire risk in glass cooktops, while allowing the heating element to achieve suitable heat transfer conditions for desired cooking performance.

### SUMMARY

In an aspect, there is provided an electric cooking apparatus. The apparatus comprises a surface for supporting cookware, a heat source located below the surface, and a heat limiter for modulating operation of a heat output from the heat source which may prevent unintended autoignition of cooking oil.

According to an aspect, there is provided a heat modulating system comprising: a heat source; a temperature sensor proximate the heat source; and a controller in connection with the temperature sensor and the heat source, wherein the controller modulates a rate of temperature increase of the heat source based on temperature detected by the temperature sensor, and at a temperature set point detected by the temperature sensor the controller modulates power to the heat source to help to prevent unintended autoignition of cooking oil.

In some embodiments, the controller modulates the heat source based, at least in part, on whether the temperature detected by the temperature sensor reaches or exceeds the temperature set point.

In some embodiments, the controller modulates power to the heat source by cycling power to the heat source on and off.

In some embodiments, the controller modulates power to the heat source by modulating current flow to the heat source.

In some embodiments, the temperature sensor is connected to the heat source and the controller, and the controller modulates power to the heat source by disconnecting power supply to the heat source.

In some embodiments, the heat modulating system further comprises a temperature control bypass to override the controller.

In some embodiments, the temperature control bypass includes a motion sensor, and upon the motion sensor detecting motion, the temperature control bypass overriding the controller.

In some embodiments, the temperature control bypass includes a user input to the controller.

In some embodiments, the temperature set point is determined based on at least one of a predetermined value, a user input, and detected conditions.

In some embodiments, the predetermined value is based on at least one of an autoignition point, a smoke point, a flash point, and a fire point.

In some embodiments, the predetermined value is based on at least one of a thickness of a cooking surface and a material of the cooking surface.

In some embodiments, the detected conditions include at least one of a mass of cookware and a mass of contents in the cookware.

In some embodiments, the mass of contents in the cookware is determined based on a combined mass of the cookware and the contents and the mass of the cookware.

In some embodiments, the heat modulating system further comprises a timer in communication with the controller, the controller modulating power to the heat source based at least in part on time elapsed at the temperature set point.

In some embodiments, the heat modulating system further comprises a display to indicate a status of the controller.

In some embodiments, the heat modulating system further comprises a communication module in communication with the controller, for communication with a mobile device.

In some embodiments, the controller includes a switch that toggles the heat source between an on state and an off state.

In some embodiments, the switch is configured to toggle the heat source at least about 2 times per minute.

In some embodiments, the switch has a rating of at least 1×10⁶ cycles.

In some embodiments, the power to the heat source is modulated based, at least in part, on whether the temperature detected by the temperature sensor reaches or is within a variance temperature range having an upper temperature limit and a lower temperature limit.

In some embodiments, the temperature set point is within the variance temperature range and the variance temperature range is less than about 50° C.

According to another aspect, there is provided an electric cooking apparatus comprising: the heat modulating system as described herein.

Other features will become apparent from the drawings in conjunction with the following description.

### BRIEF DESCRIPTION OF DRAWINGS

In the figures which illustrate example embodiments,

FIG. 1 is a high-level block diagram of a heat modulation system, according to an embodiment;

FIG. 2 is a high-level block diagram of a computing device of the heat modulation system of FIG. 1, according to an embodiment;

FIG. 3 is a perspective view of an electric cooking appliance, according to an embodiment;

FIG. 4 is a perspective view of the electric cooking appliance of FIG. 3 with the glass surface removed;

FIG. 5 is a perspective view of a heating assembly of the electric cooking appliance of FIG. 3;

FIG. 6 is a perspective view of a heating assembly mounted to a housing of the electric cooking appliance of FIG. 3;

FIG. 7 is a graph illustrating the temperature of oil heated in a pan over time, according to an embodiment;

FIG. 8 is a graph illustrating the temperature of oil heated in a pan over time, according to an embodiment; and

FIG. 9 is a graph illustrating current applied to a heat source of the oil heated in the pan of FIG. 8.

### DETAILED DESCRIPTION

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “10 mm” is intended to mean “about 10 mm”.

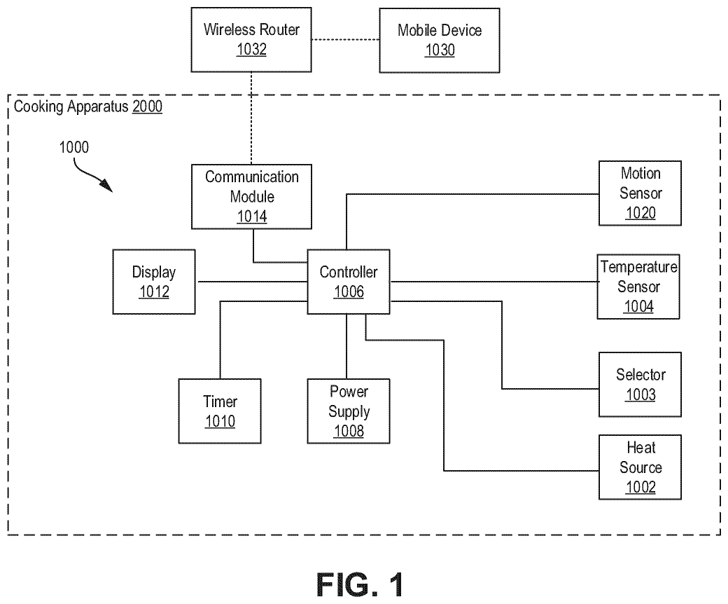

FIG. 1 is a high-level block diagram of a heat modulation system 1000, in an embodiment, for modulating operation of a heat output from a heat source 1002, for example, to achieve a desired cooking performance or to help prevent autoignition, as described in further detail below. Heat source 1002, and one or more other components of heat modulation system 1000, may be housed within a cooking apparatus 2000, for example, an electric cooking apparatus such as a glass top stove. Cooking apparatus 2000 may include a surface for supporting cookware, and heat source 1002 may be located below the surface for heating the cookware.

In addition to heat source 1002, in some embodiments, heat modulation system 1000 further includes a selector 1003, a temperature sensor 1004, a controller 1006, a power supply 1008, a timer 1010, a display 1012, a communication module 1014 and a motion sensor 1020.

As shown in FIG. 1, in some embodiments, heat source 1002, selector 1003, temperature sensor 1004, motion sensor 1020 is connected to controller 1006. Controller 1006 is powered by power supply 1008. Controller 1006 is further in communication with timer 1010, display 1012, and communication module 1014. Communication module 1014 may be wirelessly connected with wireless router 1032, in turn connected to mobile device 1030 by way of a network such as, for example, a local area network (LAN), wide area network (WAN), or the Internet.

While embodiments are described herein with reference to an electric cooking apparatus having an electrical heating coil, it will be appreciated that temperature limiting techniques as described herein may be applied to a variety of possible stovetops beyond electrical heating coil, such as induction, gas, ceramic top. Furthermore, application of the temperature limiting techniques described herein may be applied to other cooking appliances or devices such as hot plates.

In some embodiments, heat source 1002 is an electrical heating coil or an infrared halogen lamp. Heat source 1002, when activated, transfers heat to cookware supported on the surface of cooking apparatus 2000, for example, by infrared energy through the surface and by convective heat transfer to the surface followed by conduction to the cookware.

If heat source 1002 were in direct contact with the surface, temperature gradients in the surface between the portions of the surface in contact with the heat source and those portions not in contact with the heat source may cause stresses that weaken the surface. As such, in some embodiments, heat source 1002 is spaced away from the surface. In some embodiments, the heat source is from about 16 mm to about 20 mm below the bottom of the surface.

In some embodiments, the surface of cooking apparatus 2000 is a glass surface. In some embodiments, the glass surface permits the transmission of infrared radiation therethrough. This may, for example, allow energy from the heat source to be transferred to the cookware with relatively low losses and lag due to absorption and re-transmission by the surface.

In some embodiments, heat source 1002 may be a heating element having a rated power (or heat) output of between about 1100 W and about 2400 W. In some embodiments, the heating element has a rated power output of about 2400 W. In some embodiments, the size of the heating element is correlated with the rated power output.

In some embodiments, heat source 1002 is housed in a heater housing in cooking apparatus 2000. In some embodiments, the heater housing includes a bottom and a sidewall, and the heat source is mounted to the housing proximate to a top surface of the bottom. In some embodiments, the sidewall is configured to abut the bottom of the surface. The abutment of the sidewall against the bottom of the surface may provide a spacing between the bottom of the surface and the heat source. In some embodiments, the housing is made from a refractory material. In some embodiments, the heater housing and the surface define a housing volume surrounding heat source 1002 such that the air in the housing volume is heated to facilitate convective heat transfer from the heat source to the surface. Further, in some embodiments, the housing allows heat source 1002 to be placed proximate to the surface without directly contacting the surface. In some embodiments, heat source 1002 is embedded in at least a portion of the heater housing.

In some embodiments, the heater housing is biased against the bottom of the surface. In some embodiments, springs, such as coil springs or leaf springs, bias the heater housing against the bottom of the surface.

In some embodiments, heat modulation system 1000 includes a secondary heat source, connected to controller 1006, for transferring heat to cookware supported on the surface of cooking apparatus 2000. The secondary heat source may be for transferring heat to the same cookware as heat source 1002. The secondary heat source may be mounted below the glass surface of cooking apparatus 2000, and adjacent to heat source 1002.

In some embodiments, the secondary heat source is smaller than the heat source. Similar with the heat source, in some embodiments, the secondary heat source is mounted within a secondary heater housing. The secondary heater housing, like the first heater housing may include a bottom and a sidewall to define a secondary heater volume. As will be appreciated, heat modulation system 1000 may include multiple heat sources, for example, four burner glasstops, and each of the multiple heat sources may be modulated independently, or in any combination.

In some embodiments, the secondary heat source may be a secondary heating coil for use adjacent and concentric a heating coil of heat source 1002. In an example, a primary coil may be always on, and a secondary coil switches on/off, which may allow for more precise temperature control.

In some embodiments, heat modulation system 1000 includes a selector 1003 to set a heat setting for operation of heat source 1002. In some embodiments, selector 1003 may be connected to controller 1006, as shown in FIG. 1. In some embodiments, connected directly between power supply 1008 and heat source 1002 to define the heat setting of heat source 1002.

In an example, selector 1003 may include a selector knob and a burner control switch or an infinite switch.

In some embodiments, selector 1003 includes a knob or a dial. In some embodiments, cooking apparatus 2000 includes an indicia on the surface indicating a rotational position of the knob or the dial. In some embodiments, the rotation of the knob adjusts the value displayed on display 1012, such as a 7-segment LED.

In some embodiments, selector 1003 may be a digital or an analog selector.

In some embodiments, a digital selector 1003 includes buttons to increase or decrease the heat output of the heat source. In some embodiments, the buttons are selected from capacitive buttons, membranous buttons, or a combination thereof. In some preferred embodiments, the buttons are capacitive buttons, which have higher heat tolerance than membranous buttons. In some embodiments, the buttons receive instructions through the surface. Such buttons may improve maintenance of cooking apparatus 2000, for example, by avoiding crevices or other junctions where matter can accumulate and by simplifying cleanup.

In some embodiments, selector 1003 includes an on/off toggle to enable the selection of the heat output and/or to permit the supply of power to heat source 1002. The on/off toggle may help prevent a user from accidentally turning on the stove. The on/off toggle can be provided as a switch, a button (such as a button of the type used for the output selector), or some combination thereof.

In some embodiments, selector 1003 can be used to select heat output settings based on a temperature at the temperature sensor.

In some embodiments, heat modulation system 1000 includes a temperature sensor 1004 to detect a temperature at or adjacent various components of heat modulation system 1000 or cooking apparatus 2000, such as heat source 1002. In an example, temperature sensor 1004 may be located proximate the surface of cooking apparatus 2000 to detect a temperature proximate the surface for use in temperature modulation or temperature limiting control.

In some embodiments temperature sensor 1004 is located between heat source 1002 and the surface of cooking apparatus 2000. In some embodiments, temperature sensor 1004 is mounted through a hole or notch in the sidewall of the heater housing. In some embodiments, temperature sensor 1004 contacts the surface. In some embodiments, temperature sensor 1004 is integral to the surface.

In some embodiments, temperature sensor 1004 may be used to extrapolate a temperature, for example of a component of heat modulation system 1000 or cooking apparatus 2000, from a sensed temperature, for use in temperature modulation or temperature limiting control.

If the temperature sensor 1004 is placed too close to the heat source, the sensed temperature may not accurately reflect the temperature at the cookware. The placement of the temperature sensor 1004 proximate but below the surface, may improve the ability of a user to clean and maintain the cooking apparatus while maintaining meaningful temperature readings.

In some embodiments, temperature sensor 1004 includes a temperature probe, a thermocouple, a fiber optic temperature sensor, a resistive temperature sensor, an infrared sensor, a thermistor, a polymer-derived ceramics (PDC) sensor, or other suitable temperature sensing device.

In some embodiments, the temperature sensor 1004 is a thermostat, which may also act as a switch. In some embodiments, the thermostat may be a bimetallic strip. In some embodiments, the thermostat is a combination bi-metal and hyper thermostat. In some embodiments, the thermostat may be rated for 10,000 to 20,000 cycles. In some embodiments, the thermostat may be rated for a higher number of cycles, such as 1.5 million cycles, or other suitable thermostat. In some embodiments, a higher cycle-rated thermostat may be provided in a larger form-factor, for example, as compared to traditional thermostats, allowing for bigger components having a longer lifespan.

Power supply 1008 of heat modulation system 1000 may include, for example, 240 V, 208 V or 120 VAC, 60 Hz electrical power.

Heat source 1002 may draw between 1000 W and 5000 W.

In some embodiments, heat modulation system 1000 includes a timer 1010. Timer 1010 may be, for example, an analog or digital timer. Timer 1010 may measure elapsed time.

In some embodiments, timer 1010 may measure cooking time and communicate measured time to controller 1006 for use in temperature limiting control.

Timer 1010 may be configured to provide an aspect of temperature modulation or temperature limiting control, by modulating heat source 1002 (for example, powering on and off) based on a time elapsed, instead of or in conjunction with sensed temperature.

In some embodiments, timer 1010 may operate in sync with a microcontroller clock of controller 1006.

Heat modulation system 1000 includes controller 1006 configured to provide temperature limiting control, in some embodiments, by receiving a temperature reading from temperature sensor 1004 and modulating a heat output of the heat source 1002. Controller 1006, as a heat output modulator, may be configured to modulate the heat output of a heat source 1002 to prevent the temperature reading from the temperature sensing from exceeding a temperature set point. In some embodiments, modulation of the heat output of heat source 1002 may be achieved by modulating the current provided to heat source 1002.

In some embodiments, controller 1006 may include a heat output modulator such as a switch. In some embodiments, controller 1006 may include a thermal cutoff such as a thermal switch, which is normally open above a certain temperature, and closes when the temperature drops below a given temperature. As such, controller 1006 may provide temperature limiting control by controlling current to heat source 1002.

Since the heat source of a glass-top stove may not be easily replaceable, unlike with electric coil stovetops, the heat output modulator should have sufficient longevity. Stoves typically expected to have a duty life of about 13 years. The duty life of the cooking appliance is based partly on the switch rating and partly on a user's usage of the appliance. Typical usage may be estimated based on typical cooking sessions of between 20 and 30 minutes, and a frequency of 2 to 3 cooking sessions per day. In some embodiments, the switch has a rating of at least 2×10⁴, 10⁵, 10⁶, or 1.5×10⁶ cycles.

In an example, switching may be performed by temperature sensor 1004 embodied as a thermostat, for example a bimetallic strip, and provide switching when the thermostat is above or below a designated temperature—normally open at a temperature above the designated temperature and closes below the designated temperature.

In some embodiments, controller 1006 may include a computing device 1200, which may be disposed within cooking apparatus 2000, and described in further detail, below.

Controller 1006 may modulate the temperature being output by heat source 1002 by switching on and off current from power supply 1008 to heat source 1002. In another example, controller 1006 may modulate current to heat source 1002, for example, by limiting current from power supply 1008 to heat source 1002.

In an example, controller 1006 may provide pulse-width modulation of a power relay in connection with power supply 1008. Thus, a duty cycle may be set to modulate heat source 1002, for example, by modifying one or both of time on and time off, for example, on 2 minutes and off 2 minutes, on 2 minutes and off 1 minute, etc.

In some embodiments, controller 1006 may implement a proportional-integral-derivative (PID) controller (or one or more components thereof) to modulate control of heat source 1002.

In some embodiments, controller 1006 may modulate power supplied to one or more of multiple heat sources 1002. For example, a first heat source may comprise a non-cycling resistive heating wire and a second heat source may comprise one or more cycling resistive heating wires. The non-cycling resistive heating wire may remain energized at all times that the heat source is activated. The cycling resistive heating wire may be cycled on and off, to module temperature as described herein.

When the temperature is below a temperature set point, controller 1006 may be configured to enable heating by the heat source. As the sensed temperature approaches or reaches the temperature set point, controller 1006 decreases the heat output from the heat source.

In some embodiments, controller 1006 may detect the presence of cookware on a surface of cooking apparatus 2000. In some embodiments, a strain gauge may be implemented on or adjacent a surface of cooking apparatus 2000, in communication with controller 1006, to detect the presence and/or mass of a cookware (and contained material within the cookware) on a surface of cooking apparatus 2000. In some embodiments, temperature limiting control by controller 1006 may only be performed if cookware is detected.

The temperature set point may be based in part on one or more of an autoignition point, a smoke point, a flash point, and a fire point of a substance in cookware.

An autoignition point is the lowest temperature at which a substance spontaneously ignites in normal atmosphere without an external source of ignition, such as a flame or spark. This temperature is required to supply the activation energy needed for combustion.

A smoke point, also known as burning point, is the temperature at which, under specific and defined conditions, a substance begins to produce a continuous bluish smoke that becomes visible. Smoke point values can vary greatly, depending on factors such as the volume or substance (such as oil) utilized, the size of the container, the presence of air currents, the type and source of light, as well as the quality of the oil and its acidity content (otherwise known as the free fatty acid (FFA) content).

A flash point is the lowest temperature at which vapours of a volatile material will ignite when given an ignition source.

A fire point is the lowest temperature at which vapours of a material will keep burning after the ignition source is removed. The fire point is higher than the flash point, because at the flash point more vapour may not be produced rapidly enough to sustain combustion.

The placement of temperature sensor 1004 may affect the temperature set point and/or the variance temperature. For example, if temperature sensor 1004 were in contact with the cooking surface of cookware sitting on top of the surface, the temperature set point may be defined just below the autoignition temperature of the contents of the cookware. However, such placement may be impractical since temperature sensor 1004 placed in the cookware itself may present a physical barrier that interferes with the user's cooking experience.

In those embodiments where temperature sensor 1004 is placed between heating source 1002 and the surface on which cookware is placed, the temperature set point may be higher than the autoignition temperature in order to maintain the temperature of the contents of the cookware below the autoignition temperature of the contents of the cookware.

In some embodiments, for example, when temperature sensor 1004 is located in the housing volume surrounding heat source 1002, the temperature set point is about 535° C. In contrast, traditional glass top stoves have a temperature limiter set at approximately 670° C., which is selected to maintain the integrity of the glass surface and can result in unintended autoignition of oils.

The temperature set point may be determined based on one or more of the following: (i) a predetermined temperature, (ii) user selection(s), and (iii) detected conditions, each of which are described in further detail below.

A predetermined temperature may be selected to help to prevent the ignition of cooking oil contained in cookware sitting on top of the surface. For example, the auto-ignition temperature of common cooking oils may be above 380° C. The predetermined temperature may be selected to help to prevent a substance from reaching its autoignition point, and therefore the predetermined temperature may be offset by a certain number of degrees below the autoignition temperature.

Autoignition temperatures of certain common cooking oils may be found, for example, in Krystyna Buda-Ortins and Dr. Peter Sunderland, “Auto-Ignition of Cooking Oils”, University of Maryland Department of Fire Protection Engineering, May 2010; in studies conducted by Primaira from 2012-2014 for the US Consumer Products Safety Commission, including the reports entitled “Pan-Bottom Temperature Limiting Control Technology testing—Performance period July 2013-July 2014”, “Pan Temperature-Limiting Control Technology to Reduce Incidence of Unattended Cooking Fires”, and “Refinement of Temperature-Limiting Control Systems for Preventing Oil Ignition on Gas and Electric Cooktops”; and in Corey Ray Hanks, “Potential Ignition Sources from Residential Electric Cooktops”, Online Theses and Dissertions 267, East Kentucky University, all herein incorporated by reference.

A predetermined temperature may be based on material of a surface supporting cookware, thickness of the surface, cookware parameters (for example, size, material, thickness), and contents of the cookware.

A predetermined temperature may be determined through testing, described in further detail below, in an example, based on a lowest common denominator (such as the lowest autoignition point, most conductive pan, and using an amount of oil likely ignite the quickest) and the predetermined temperature may be set to that condition.

In some embodiments, a predetermined temperature may be determined for a particular stovetop model, stovetop models tested on a model by model basis.

In some embodiments, a temperature set point may be determined based on user selection(s). For example, a user may input to heat modulation system 1000 various parameters such as the material and thickness of the surface supporting the cookware vessel, cookware parameters such as size of the cookware, material, and thickness, and contents of the cookware (for e.g., cooking oil such as canola oil). Based on at least the user input, heat modulation system 1000 may then be able to select an appropriate temperature set point for limiting the sensed temperature from exceeding the temperature set point. In some embodiments, user input may indicate that a user is not performing any dangerous functions, and override any heat limiting functionality. In some embodiments, user input may indicate that heat limiting control should be activated. In some embodiments, parameters of a user input may be used to determine a temperature set point.

In some embodiments, a temperature set point may be determined based on detected conditions, such as material of cookware, size of cookware, size of cookware relative to heat source 1002 or a heating coil, mass of cookware, flatness of cookware (for e.g., flatter cookware may provide more contact with a surface of cooking apparatus 2000 and better conductivity), use of a lid for cookware, type of content (for e.g., food) in cookware, volume of content in cookware, mass of content in cookware.

In some embodiments, controller 1006 may include a bypass for temperature limiting control. For example, a user may be able to select a “boiling water” option, or a more general bypass button, to override temperature limiting control.

In an example, heat limiting system 1000 may detect the presence of cookware on a stovetop, such that bypass functionality is only available if cookware is detected.

In some embodiments, temperature limiting control may be bypassed if motion sensor 1020 is activated, for example, indicating that a user is in proximity to the stovetop, and activate temperature limiting control if no motion is detected for a period of time. In an example, motion sensor 1020 may be a passive infrared sensor, or other suitable motion sensor.

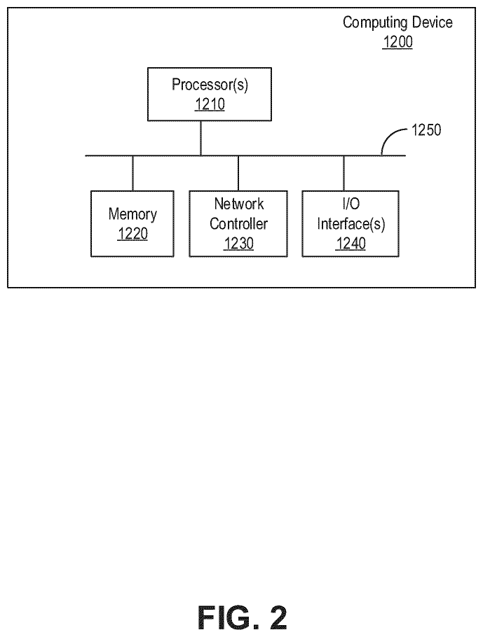

As illustrated in FIG. 2, computing device 1200 includes one or more processor(s) 1210, memory 1220, a network controller 1230, and one or more I/O interfaces 1240 in communication over bus 1250.

Processor(s) 1210 may be one or more Intel x86, Intel x64, AMD x86-64, PowerPC, ARM processors or the like.

Memory 1220 may include random-access memory, read-only memory, or persistent storage such as a hard disk, a solid-state drive or the like. Read-only memory or persistent storage is a computer-readable medium. A computer-readable medium may be organized using a file system, controlled and administered by an operating system governing overall operation of the computing device.

Network controller 1230 serves as a communication device to interconnect the computing device with one or more computer networks such as, for example, a local area network (LAN) or the Internet.

One or more I/O interfaces 1240 may serve to interconnect the computing device with peripheral devices, such as for example, keyboards, mice, video displays, and the like. Such peripheral devices may include display 1012. Optionally, network controller 1230 may be accessed via the one or more I/O interfaces.

Software instructions are executed by processor(s) 1210 from a computer-readable medium. For example, software may be loaded into random-access memory from persistent storage of memory 1220 or from one or more devices via I/O interfaces 1240 for execution by one or more processors 1210. As another example, software may be loaded and executed by one or more processors 1210 directly from read-only memory.

In some embodiments, computing device 1200 may be an embedded system or microcontroller, including a processor, memory, and input/output (I/O) peripherals on a single integrated circuit or chip, to perform the processes and store the instructions and data described herein. In an example, computing device 1200 may be a microcontroller such as an Arduino board and associated software system.

In some embodiments, heat modulation system 1000 may also include communication module 1014.

In some embodiments, communication module 1014 may be integrated with computing device 1200 of controller 1006.

In some embodiments, communication module 1014 may provide for communication between heat modulation system 1000 and a mobile device 1030, for example, by way of a wireless router 1032.

Heat modulation system 1000 may thus form a part of an “Internet of things” (“IoT”) network of physical devices embedded with computing devices, electronics, sensors, and connectivity, which may enable the devices to connect, collect and exchange data.

Communication module 1014 of heat modulation system 1000 may establish a communication channel to a local or wide area network through suitable wireless interfaces at a computing device (for example, as part of computing device 1200 of controller 1006), for example, via network controller 1230. Possible wireless interfaces include WiFi interfaces, Bluetooth interfaces, NFC interfaces, and the like. In an example, computing device 1200 may connect to a local or wide area network by way of a communication device such as wireless router 1032.

Mobile device 1030 may be a mobile computing device. Example mobile computing devices include without limitation, cellular phones, cellular smart-phones, wireless organizers, pagers, personal digital assistants, computers, laptops, handheld wireless communication devices, wirelessly enabled notebook computers, portable gaming devices, tablet computers, or any other portable electronic device with processing and communication capabilities that may communicate with another computing device such as computing device 1200.

Mobile device 1030 may connect to computing device 1200 through wireless router 1032 via a local WiFi network.

In some embodiments, mobile device 1030 may pair directly to computing device 1200, for example, by way of Bluetooth or other protocols.

Wireless router 1032 may be an IEEE 802.11-standard compliant router operating in 2.4 GHz and/or 5 GHz frequency bands.

Wireless router 1032 may be present local to heat modulation system 1000, and provide a wireless access point to connect computing device 1200 of heat modulation system 1000 with a local or wide area network.

Software components and data stored within memory 1220 of computing device 1200 may allow for basic communication and application operations related to computing device 1200, as well as remote control and/or monitoring of heat limiting system 1000 by mobile device 1030. In an example, a user may be able to shut off cooking apparatus 2000 remotely from mobile device 1030.

In some embodiments, communication module 1014 may communicate and operate in conjunction with timer 1010 such that notifications, for example, to mobile device 1030, are triggered upon an elapsed time. For example, a user may input a cooking configuration for a low heat simmering, and communication module 1014 may send a notification to mobile device 1030 that heat source 1002 remains activated. In another example, communication module 1014 may communicate to mobile device 1030 a time elapsed of activation of heat source 1002. An alert may be activated on mobile device 1030, such as a display indicating that heat source 1002 is activated, a display of time elapsed or an audible alert such as a beep.

In some embodiments, heat limiting system 1000 includes display 1012 which includes a heat output indicator communicating with selector 1003 to display configured to indicate the heat output setting. For example, in some embodiments, the heat output indicator includes at least one 7-segment LED, each LED showing a numerical value between 0-9 to indicate the heat output setting. For example, using selector 1003, a user can select heat output settings between 0 and 9, where at a heat output setting of 0, the heat source is turned off, and at a heat output setting of 9, the heat source is turned to its maximum heat output.

In some embodiments, display 1012 receives the temperature from the temperature sensor and indicates whether the temperature is above an indication temperature. In some embodiments, the indication temperature is between about 45° C. and about 55° C. Since the heat conduction of glass is relatively low, hot portions of the glass surface are generally localized to above the heat source.

As such, in some of those embodiments where more than one heat source is present, display 1012 may indicate the locations of hot spots on the glass surface. For example, display 1012 can be provided for each heat source 1002. Displays 1012 can be located proximate the heat source, proximate the output selector controlling the heat source, or both.

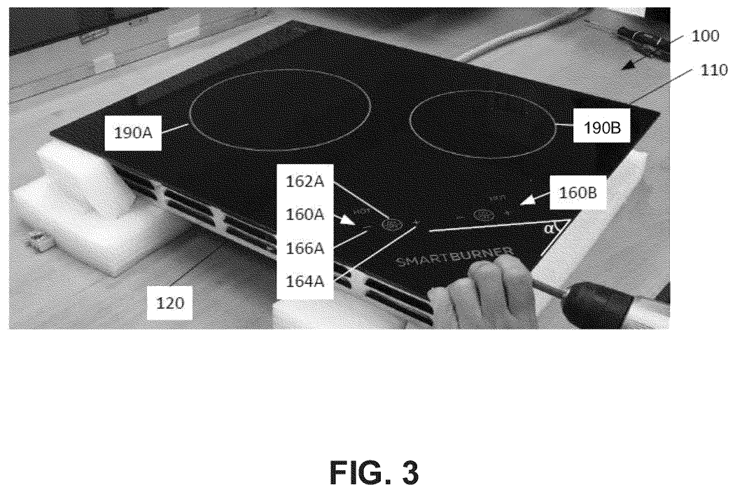

In some embodiments, cooking apparatus 2000, in which heat limiting system 1000 may be housed, is embodied as a rectangular apparatus 100 as illustrated FIGS. 3-6. In some embodiments, the rectangular apparatus may be mounted with a long side facing the user or a short side facing the user such that the user is able to access the controls without reaching behind a burner. For example, in some embodiments, the output selector is mounted on an angle, a with respect to the sides of the apparatus. In some embodiments, a is between about 30 and about 60 degrees, preferably about 45°. In some embodiments, the output selector is mounted proximate a corner of the surface.

Having reference now to FIG. 3, apparatus 100 is depicted. Apparatus 100 includes a surface 110 mounted on top of a housing 120.

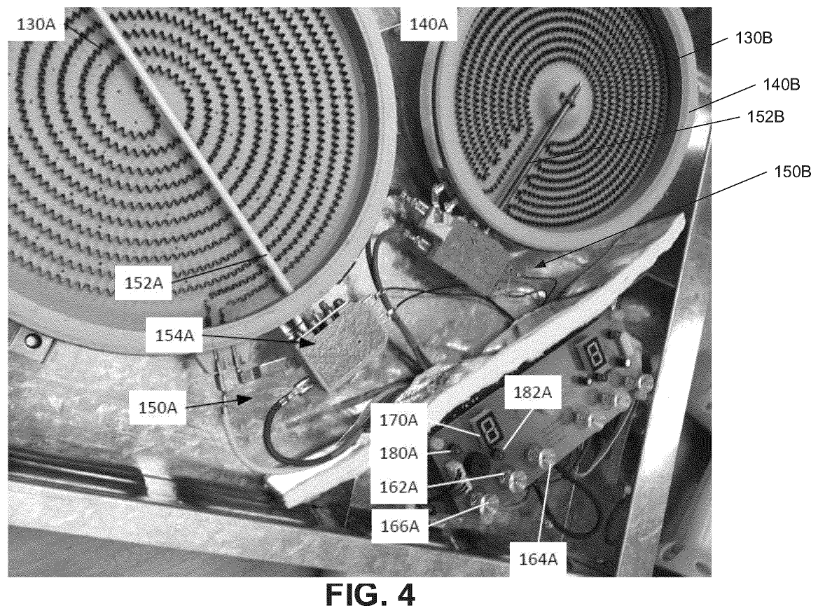

FIG. 4 shows apparatus 100 of FIG. 3 with the glass surface 110 removed. A heat source 130A, depicted as a resistive heating element, is attached to a heater housing 140A and connected to a heat limiter 150A. The heat source 130A, on receipt of power, generates a heat output. Similarly, a secondary heat source 130B is attached to a heater housing 140B and connected to a heat limiter 150B. It will be understood that in the description below, if suffix “A” or “B” is not included, then the statements can be applicable to either “set” of heat sources, housings, limiters, etc.

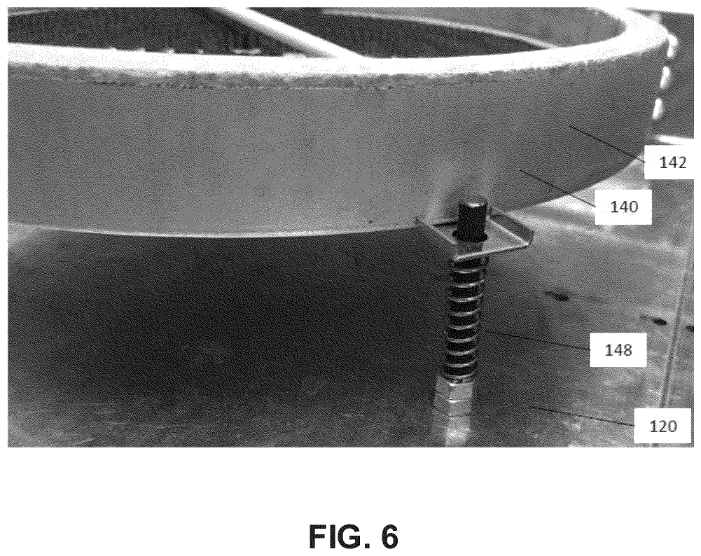

Having reference to FIG. 6, the heater housing 140 is mounted to the housing 120 underneath the glass surface 110. The heater housing 140 includes a sidewall 142 and a bottom 144. The heat source 130 is mounted on a top surface of the bottom 144 of the heater housing 140. Spring mounts 148 attached to the housing 120 bias the heater housing 140 upwardly such that when the glass surface 110 is attached to the housing 120, a top surface of the sidewall 142 abuts the bottom of the glass surface 110.

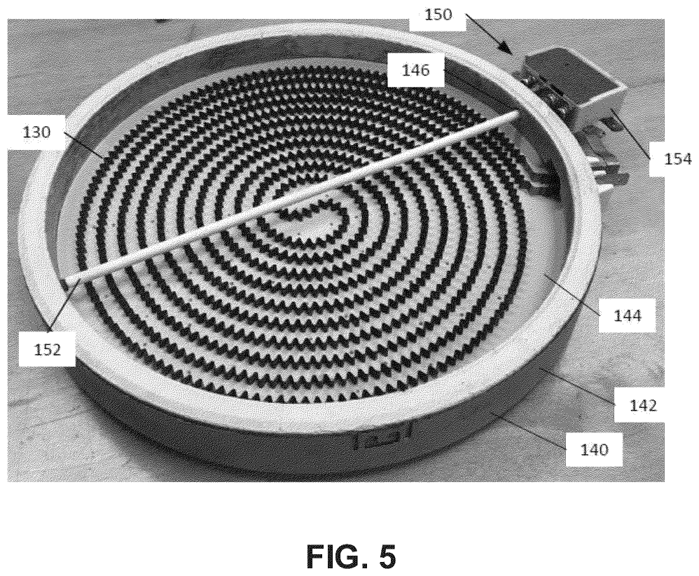

Having reference to FIG. 5, the heat limiter 150 includes a temperature sensor 152, depicted as an elongated cylindrical temperature probe, and a heat output modulator 154. The temperature sensor 152 is mounted to the heater housing 140 through a hole 146 defined by the sidewall 142. The temperature sensor 152 is positioned above the heat source 130 such that it passes over the centre of the heat source 130. The temperature sensor 152 may be affixed to the sidewall 142, for example, at a position opposite to the position of the hole 146 (such as with temperature sensor 152A), or may be cantilevered such that it is suspended over heat source 130 (such as with temperature sensor 152B) (see FIG. 4). In response to a temperature received from the sensor 152, the heat output modulator 154 can increase or decrease heat output from the heat source 130.

The apparatus also includes an output selector 160 for selecting a power provided to the heat source. The output selector 160 includes an on/off button 162, and buttons 164/166 for increasing and decreasing heat output by the heat source 130. As depicted, buttons 160 and 162 are capacitive buttons attached to the housing 120 beneath the glass surface 110. The apparatus includes a heat output indicator 170 for showing a heat output setting of the heat source 130 and an on/off indicator 172 for showing whether the heat source is toggled on by the on/off button 162.

The apparatus 100 includes a hot cooktop indicator 180 for providing an indication that the glass surface above the heat source 130 is hot. The hot cooktop indicator is located proximate the output selector 160 and/or the heat output indicator 170.

The apparatus 100 includes a heat source indicators 190A, 190B indicating the size and position of the heat sources 130 located under the glass surface 110. The heat source indicator may allow the user to position cookware directly over the heat source to enable better heating. In some of those embodiments with a secondary heat source, the surface has a secondary heat source indicator showing the size and position of the secondary heat source mounted beneath the surface.

The apparatus 100 may be placed in a “vertical” or a “horizontal” arrangement. In the “vertical” arrangement, the “length” of the side of the apparatus facing a user is shorter than the “depth” of the side extending away from the user. In the “horizontal” arrangement, the “length” of the side of the apparatus facing the user is longer than the “depth” of the side extending away from the user. The output selector 160, the heat output indicator 170, and the hot cooktop indicator 180 are arranged on the glass surface 110 on an angle such that they are accessible to a user, when apparatus 110 is mounted in a “vertical” or “horizontal” orientation. Accessibility metrics are selected from readability of heat output indicator 170, readability of hot cooktop indicator 180, the ability to reach the output selector 160 without having to reach over any heat sources 130, and any combination thereof.

In use, heat limiting system 1000 may operate to perform heat modulation, thus providing heat limiting control.

Heat modulation based solely on the heat output power of heat source 1002 may not be able to accurately control the temperature to limit ignition of cookware contents. For example, the energy required to raise the temperature of contents in cookware may be less than the energy required to maintain a temperature once an ideal cooking temperature is raised. This is because the contents may have heat capacity that resists the increase of temperature. Once reached, the heat losses to the environment may be much smaller than the heat capacity of the cookware contents, and maintaining the heat output required to bring the cookware contents up to a desired temperature may cause the contents to continue to heat beyond the desired cooking temperature. Further, reactions may further affect the heat flows from the food. For example, if a pot of water is placed on the apparatus, the temperature of the contents of the pot may be limited to 100° C. since the heat is used to effect a phase change in the water (i.e. boiling the water). After the water boils, the same heat output will start increasing the temperature inside of the pot. Other reactions during cooking may also affect the temperature.

In some embodiments, after the heat output from heat source 1002 is decreased, for example, by way of controller 1006 decreasing current to heat source 1002 or switching current supply to heat source 1002 on and off, the temperature from temperature sensor 1004 decreases until it reaches a tolerable variance temperature within a variance temperature range. Once the temperature reaches the variance temperature, the heat output from heat source 1002 in increased, for example, by way of controller 1006 increasing current to heat source 1002 or switching current supply to heat source 1002 on and off, until the temperature from temperature sensor 1004 reaches the temperature set point.

A variance temperature is provided within an operating variance temperature range having an upper temperature limit and a lower temperature limit that is cycled through. In some embodiments, the difference between the temperature set point and the variance temperature is less than 120° C., 110° C., 100° C., 90° C., 80° C., 70° C., 60° C., 50° C., 40° C., 30° C., 20° C., 10° C., 5° C., 3° C., or even 2° C. The increase and decrease of the heat output from the heat source limits the temperature at the temperature sensor to an upper operating range. Due to thermal mass of a pot or pan, and the contents therein, the temperature of the pot or pan may exhibit a less temperature variation than that experienced at temperature sensor 1004.

A smaller upper operating range may help enable better cooking performance by reducing swings in temperature. For example, the reactions in cooking may be affected by the cooking temperature. Maillard reactions start occurring at about 120° C. and increase more rapidly at about 150° C. At higher temperatures, caramelization starts occurring, which uses up sugars present in food, thereby inhibiting the Maillard reaction. Thus, fluctuations in the temperature from temperature sensor 1004 can result in fluctuations in cooking temperatures, thereby affecting the cooking of the contents in the pan. Thus, it may be possible to cook more precisely within a desired temperature range to achieve desired cooking performance.

As previously discussed, heat modulation of heat source 1002 may be achieved, for example, by controller 1006 switching on and off current supply to a heat source, and/or modulating the current flow to heat source 1002.

In some embodiments, controller 1006 includes a switch. In some embodiments, the switch toggles power supply 1008 to heat source 1002 between “on” and “off”. In some embodiments, each change of stage is considered a toggle. For example, when controller 1006 switches the heat source from “on” to “off, it is considered a toggling action; when the heat output modulator switches the heat source from “off” to “on”, it is considered a toggling action. A higher toggling rate may result in a narrower upper operating range. Conversely, if a narrower upper operating range is desired, the toggling rate may be increased. In some embodiments, in order to maintain the upper operating range, the switch toggles the heat source at least about 6 times per 20 minutes, preferably at least about 2, 3 or even 4 times per minute.

In some embodiments, the “on” state is maintained for shorter, the same length, or longer than the “off” state. In some embodiments, the length of the states is varied to maintain the temperature between the temperature set point and the variance temperature, e.g. in the upper operating range.

In some embodiments, the length of the “on” and “off” state are varied based on the heat transfer properties of the heating apparatus and the contents placed thereon. For example, the heat transfer properties may include thermal mass, thermal resistance, thermal conductivity, physical or chemical reactions (such as boiling water, browning or caramelization of food, etc.), glazing properties of the glass, ambient temperatures, heat output by the heat source, etc. In some embodiments, upon reaching the temperature set point, the heat source is toggled into the “off” state for up to about 60 seconds, 30 seconds, 20 seconds, or even 10 seconds. The temperature will then decrease until the variance temperature is reached, at which time the heat source is toggled into the “on” state for up to about 60 seconds, 30 seconds, 20 seconds, or even 10 seconds.

In some embodiments, heat modulation may be achieved by controller 1006 modulating power supply 1008 to heating source 1002, for example, by shutting down a portion of the power supply, by shutting down 1700 W of the 2100 W max output of power supply 1008. Such an arrangement may provide finer control of the heat output of the heat source than turning off the entirety of the heat source.

In some embodiments, heat source 1002 includes a plurality of independently powered heating portions, for example, multiple independent heating coils or multiple burners. The plurality of independently powered heating portions may be toggled on or off to modulate the heat output of heat source 1002.

In some embodiments, controller 1006 varies the voltage and/or current supplied to heat source 1002.

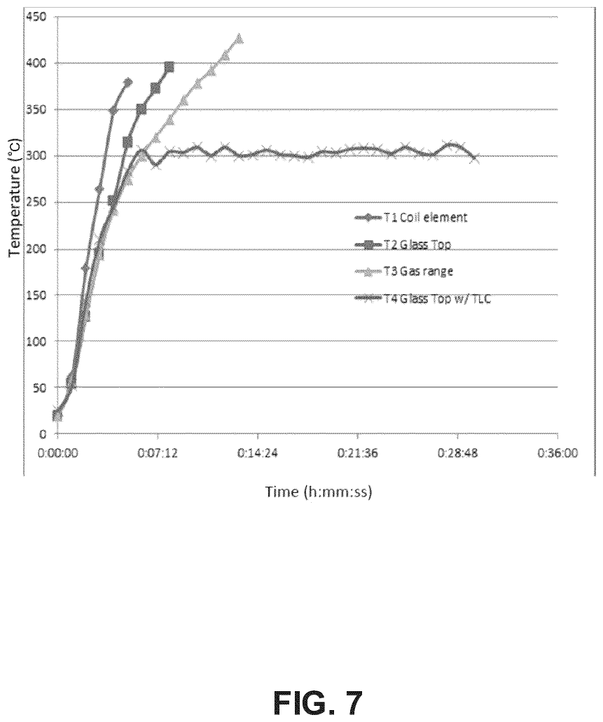

The rate of temperature increase of heat source 1002 may be modulated, since, as described with reference to experimental Example 1, below, the autoignition of cookware content such as oil may be affected by the speed to which it is heated. This may be seen, for example, in FIG. 7. In some embodiments, heat source 1002 may be modulated, for example, by cycling heat source 1002 on and off, as a detected heat approaches the set point temperature.

In some embodiments, in use, user control of selector 1003 to adjust heat settings of heat source 1002 may override temperature limiting control of controller 1006. In other embodiments, for example, in a safe setting mode previously selected by a user, user control of selector 1003 may be overridden by heat modulation performed by controller 1006.

In some embodiments, display 1012 may display that temperature is being modulated or limited by controller 1006, and furthermore what the temperature reading is from temperature sensor 1004 as well was what the set point temperature is.

### EXAMPLES

In experimental work to date, there is illustration of operation of a heat limiting system, for example as described herein, to avoid autoignition during cooking. The following examples are provided to exemplify particular features. A person of ordinary skill in the art will appreciate that the scope of the present is not limited to the particular features exemplified by these examples.

In some embodiments, the surface of a cooking apparatus at least partially transmits infrared radiation emitted by the heat source. When cookware sits on top of the surface, a portion of the transmitted infrared radiation may be reflected back toward the heater housing and a portion of the transmitted infrared radiation may be absorbed by the cookware thereby heating the cookware. Heat from the cookware may be transmitted to the surface by conduction from the cookware and some may be lost to the ambient environment through convection. If no cookware is present on the surface when the heat source is on, then a greater portion of the infrared radiation is not absorbed or reflected, which could affect the temperatures in the housing volume.

To simulate real-world cooking, cookware is placed on top of the surface when selecting the temperature set point. In some embodiments, the apparatus meets the UL 858 60A testing standard, modified for the appropriate type of heating element. For example, a pan having a bottom thickness of about 0.15 mm is placed on top of the heat source with 106 g of canola oil. The temperature set point may be selected such that the oil in the pan will not ignite for at least about 30 minutes when the heat source is outputting heat. In some embodiments, the average temperature in the pan will not exceed about 385° C. Thus, in some embodiments, a temperature set point may be defined on the basis of a relationship between a measured temperature by temperature sensor 1004 and a temperature of contents in cookware, such that an autoignition temperature of the contents is not reached and autoignition of the contents in the cookware may be avoided. A variance temperature range may be established in a similar manner by identifying a relationship between a measured temperature and a temperature of contents in cookware.

### Example 1

A test was performed similar to that of the test described in UL 858 60A, except that it is performed on various types of stoves and not limited to an electric coil stove. Having reference to FIG. 7, a pan with canola oil contained therein is heated on four different stoves: a conventional electric coil stove (T1), a conventional glass top stove (T2), a conventional gas stove (T3), and a glass top stove with a heat limiter according to an embodiment (T4). The stoves are turned to high and the temperature of the oil in the pan is plotted against the time. The test for any particular stove ended upon: 1) the ignition of the oil; or 2) after 30 minutes. The x-axis illustrated in FIG. 7 represents time, and the y-axis represents the measured temperature of the oil in the pan.

Of the stoves where ignition was observed, the rate of temperature increase was highest for T1, followed by T2 and T3. From this, it could be observed that the auto-ignition temperature may be defined within a temperature range, and correlated with a rate of temperature increase.

For T4, the rate of increase of the temperature of the cookware was between that of T2 and T3. However, rather than continuing to heat the cookware, the heat limiter toggled the heat source, thereby maintaining the temperature of the cookware at a temperature of about 300° C. At this temperature, the oil in the pan did not ignite after 30 minutes and the test was concluded.

The ignition of the oil may also be affected by the speed at which it is heated (e.g. a rate of temperature increase of the oil). For example, as illustrated in FIG. 7, a pan with canola oil contained therein is heated on: a conventional electric coil stove, a conventional glass top stove, a conventional gas stove, and a glass top stove according to an embodiment. The ignition temperature is the temperature at which the line for each type of stove terminates. If the oil did not ignite after 30 minutes of heating, the test was ended. The autoignition temperature of an oil heated on an electric coil stove, glass top stove, and gas stove was about 375° C., about 400° C., and about 425° C., respectively.

As can be seen from FIG. 7, the rate at which the temperature of the oil increased was negatively correlated with the auto-ignition temperature of the oil. For example, a temperature of the oil heated on an electric coil stove increased more quickly than a temperature of the oil heated on a glass top stove or a gas range. Oil heated in a pan on a glass top stove according to an embodiment exhibited a rate of temperature increase similar to a conventional glass top stove. However, upon the detection of the temperature set point, the heat limiter modulated the heat output from the heat source such that the oil does not reach the auto-ignition temperature of the oil. In some embodiments, the heat limiter modulates the heat output from the heat source such that a rate of temperature increase is about equal to that of a non-limited heat source until about the temperature set point. In other embodiments, the heat limiter modulates the heat output from the heat source such that the rate of temperature increase is lower than that of a non-limited heat source such that a higher in-pan temperature can be achieved than the non-limited heat source.

### Example 2

The stove of T4 was turned to high, for example, the maximum power setting of the burner to deliver the maximum power to the burner, for example 2400 W for an 8″ burner or 1500 W for a 6″ burner, to show toggling times of the stove, testing the timing of the on/off intervals of the burner and the overall temperature recorded. The stove was tested with no cookware, a pot of water, and a frying pan with oil. The stove was turned to high and the times at which the heat limiter toggled the heat source was recorded. The test was conducted for 5 cycles. The ambient temperature was 20° C. and the supply voltage was 229V.

The results of the no cookware test are shown in Table 1, below. The values in the “Off” and “On” columns are the recorded times, after initial power on, that the burner is turned “Off”, at a first temperature set point, and then the recorded time that it turned back “On” again, at a second temperature set point, respectively. The first temperature set point and the second temperature set point may be the same detected temperature by a temperature sensor such as set point of a thermostat.

| | Off | On | Time Difference |
|---|---|---|---|
| First Cycle | 3:14 | 3:31 | 0:17 |
| Second Cycle | 4:03 | 4:21 | 0:18 |
| Third Cycle | 4:49 | 5:09 | 0:20 |
| Fourth Cycle | 5:34 | 5:55 | 0:21 |
| Fifth Cycle | 6:18 | 6:38 | 0:20 |

The pot used for the pot of water test was a Starfrit Starbasix™ pot. The pot was filled with 3 L of 19° C. water. The results of the pot of water test are shown in Table 2, below.

| | Off | On | Time Difference |
|---|---|---|---|
| First Cycle | 3:33 | 3:52 | 0:19 |
| Second Cycle | 4:42 | 5:02 | 0:20 |
| Third Cycle | 5:42 | 6:01 | 0:19 |
| Fourth Cycle | 6:40 | 7:01 | 0:21 |
| Fifth Cycle | 7:36 | 7:56 | 0:20 |

The pan used for the frying pan with oil test was T-Fal™ frying pan. The frying pan had 150 mL of oil placed therein. The results of the frying pan with oil test are shown in Table 3, below.

| | Off | On | Time Difference |
|---|---|---|---|
| First Cycle | 3:08 | 3:42 | 0:34 |
| Second Cycle | 4:01 | 4:21 | 0:20 |
| Third Cycle | 4:48 | 5:15 | 0:27 |
| Fourth Cycle | 5:29 | 5:59 | 0:30 |
| Fifth Cycle | 6:22 | 6:47 | 0:27 |

From the tests, it could be seen that the toggling was at a faster rate for the test with no cookware as compared to the frying pan with oil. This may be, at least in part, because there is no cookware on top of the stove to provide a thermal mass to temper ambient heat losses, resulting in the temperature decreasing relatively rapidly.

Similarly, the toggling times for the pot of water than for the frying pan with oil. This may be, at least in part, because the evaporative heat losses due to the water results in a heat flow that decreases the temperature at the temperature sensor resulting in relatively short periods in the “off” state, and because the thermal mass of the water and the evaporative heat losses results in a relatively long period in the “on” state.

In contrast, in the frying pan with oil test, the heat limiter maintained the heat source in the “on” state for a period shorter than the “off” state. This is due, in part due to the heat transfer properties of the frying pan with oil, as compared to no cookware and a pot of water.

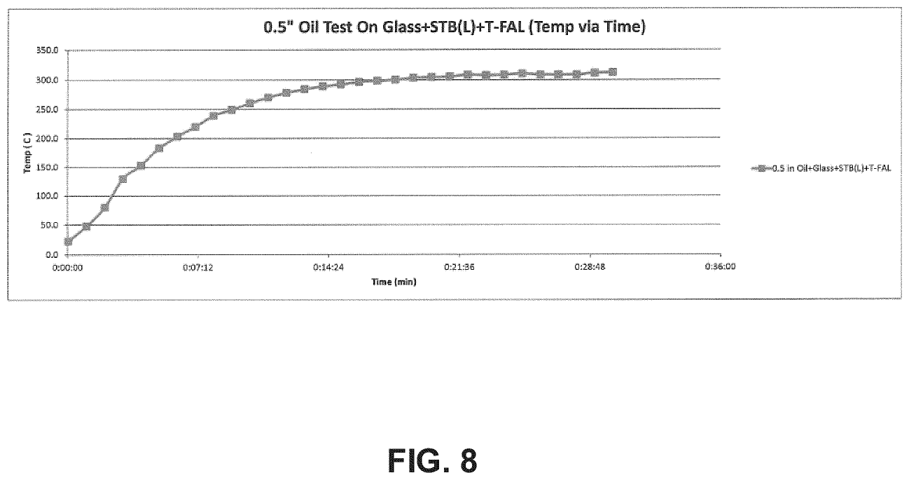

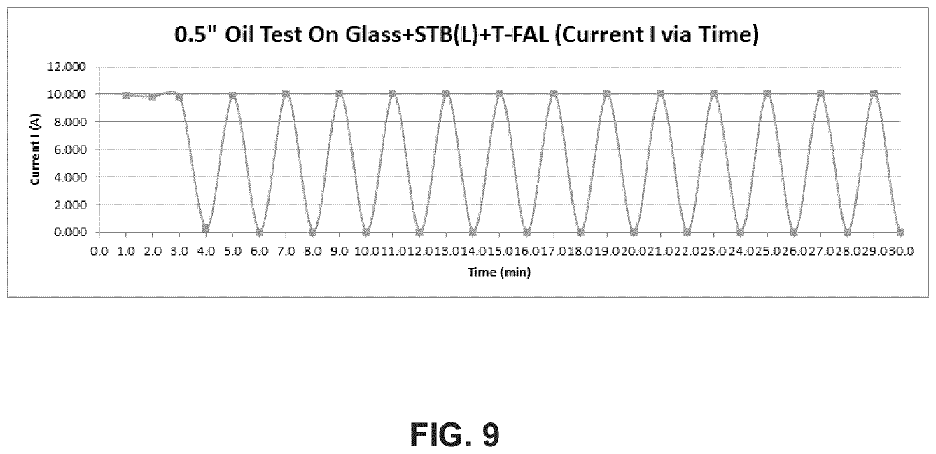

FIG. 8 is a graph illustrating the temperature of 0.5 inches of oil heated in a T-Fal™ frying pan over time. FIG. 9 is a corresponding graph illustrating current applied to a heat source of the oil heated in the pan of FIG. 8.

As shown in FIG. 9, a thermostat may cycle on and off every minute to maintain a temperature of oil in the pan just above 300° C. In some embodiments, a thermostat may cycle on and off twice a minute to maintain within a tolerable range of a temperature set point.

Every document cited herein, including any cross referenced or related patents or applications, is hereby incorporated by reference in its entirety. The citation of any document is not an admission that it is prior art with respect to any invention disclosed or claimed herein or that it alone, or in any combination with any other reference or references, teaches, suggests or discloses any such invention. Should any meaning or definition of a term in this document conflict with any meaning or definition of an identical term in a document incorporated by reference, the meaning or definition assigned to that term in this document shall govern.

Of course, the above described embodiments are intended to be illustrative only and in no way limiting. The described embodiments are susceptible to many modifications of form, arrangement of parts, details and order of operation. The disclosure is intended to encompass all such modification within its scope, as defined by the claims.

What is claimed is:

1. A heat modulating system comprising:
a heat source;
a temperature sensor proximate the heat source; and
a controller in connection with the temperature sensor and the heat source,
wherein the controller modulates a rate of temperature increase of the heat source based on temperature detected by the temperature sensor, and at a temperature set point detected by the temperature sensor the controller modulates power to the heat source to help to prevent unintended autoignition of cooking oil.

2. The heat modulating system of claim 1, wherein the controller modulates the heat source based, at least in part, on whether the temperature detected by the temperature sensor reaches or exceeds the temperature set point.

3. The heat modulating system of claim 1 or 2, wherein the controller modulates power to the heat source by cycling power to the heat source on and off.

4. The heat modulating system of any one of claims 1 to 3, wherein the controller modulates power to the heat source by modulating current flow to the heat source.

5. The heat modulating system of any one of claims 1 to 4, wherein the temperature sensor is connected to the heat source and the controller, and the controller modulates power to the heat source by disconnecting power supply to the heat source.

6. The heat modulating system of any one of claims 1 to 5, further comprising a temperature control bypass to override the controller.

7. The heat modulating system of claim 6, wherein the temperature control bypass includes a motion sensor, and upon the motion sensor detecting motion, the temperature control bypass overriding the controller.

8. The heat modulating system of claim 7, wherein the temperature control bypass includes a user input to the controller.

9. The heat modulating system of any one of claims 1 to 8, wherein the temperature set point is determined based on at least one of a predetermined value, a user input, and detected conditions.

10. The heat modulating system of claim 9, wherein the predetermined value is based on at least one of an autoignition point, a smoke point, a flash point, and a fire point.

11. The heat modulating system of claim 9 or 10, wherein the predetermined value is based on at least one of a thickness of a cooking surface and a material of the cooking surface.

12. The heat modulating system of any one of claims 9 to 11, wherein the detected conditions include at least one of a mass of cookware and a mass of contents in the cookware.

13. The heat modulating system of claim 12, wherein the mass of contents in the cookware is determined based on a combined mass of the cookware and the contents and the mass of the cookware.

14. The heat modulating system of any one of claims 1 to 13, further comprising a timer in communication with the controller, the controller modulating power to the heat source based at least in part on time elapsed at the temperature set point.

15. The heat modulating system of any one of claims 1 to 14, further comprising a display to indicate a status of the controller.

16. The heat modulating system of any one of claims 1 to 15, further comprising a communication module in communication with the controller, for communication with a mobile device.

17. The heat modulating system of any one of claims 1 to 16, wherein the controller includes a switch that toggles the heat source between an on state and an off state.

18. The heat modulating system of claim 17, wherein the switch is configured to toggle the heat source at least about 2 times per minute.

19. The heat modulating system of claim 17 or 18, wherein the switch has a rating of at least 1×10⁶ cycles.

20. The heat modulating system of any one of claims 1 to 19, wherein the power to the heat source is modulated based, at least in part, on whether the temperature detected by the temperature sensor reaches or is within a variance temperature range having an upper temperature limit and a lower temperature limit.

21. The heat modulating system of claim 20, wherein the temperature set point is within the variance temperature range and the variance temperature range is less than about 50° C.

22. An electric cooking apparatus comprising:
the heat modulating system of any one of claims 1 to 21.
